(19) United States
(12) Patent Application Publication
(10) Pub. No.: US 2019/0340984 A1
(43) Pub. Date: Nov. 7, 2019

(54) GRAPHICS PROCESSING APPARATUS AND PROCESSING METHOD THEREOF

(71) Applicants: HKC Corporation Limited, Shenzhen City, Guangdong (CN); Chongqing HKC Optoelectronics Technology Co., Ltd., Chongqing (CN)

(72) Inventors: Wenqin ZHAO, Chongqing (CN); Wei CHEN, Chongqing (CN)

(21) Appl. No.: 15/580,409

(22) PCT Filed: Sep. 19, 2017
(86) PCT No.: PCT/CN2017/102197

§ 371 Date: Dec. 7, 2017

(30) Foreign Application Priority Data
Aug. 25, 2017 (CN) 201710742988.2

(51) Int. Cl. G09G 3/36; G09G 3/34; H04N 9/69

(52) U.S. Cl. CPC G09G 3/3607; G09G 2320/0276; H04N 9/69; G09G 3/3413

(57) ABSTRACT

This application relates to a graphics processing apparatus and a processing method thereof. The graphics processing apparatus includes: a correction gamma module adjust a color coordinate of a panel; a first gamma module, when a primary pixel is input, output a correction module having a correspondence with the first gamma module; a second gamma module, when a secondary pixel is input, output a correction module having a correspondence with the second gamma module; a first selection and corresponding module, electrically coupled to the first gamma module and the second gamma module separately, and select a high potential output for the primary pixel or select a low potential output for the secondary pixel; and a second selection and corresponding module, electrically coupled to the correction gamma module, the first selection and corresponding module, and a high frequency detection unit separately, and configured to output graphics pixel data.

### BACKGROUND

### Technical Field

This application relates to a graphics processing method, and in particular, to a graphics processing apparatus and a processing method thereof.

### Related Art

Recently, liquid crystal displays (LCD) are widely used. With the improvement of drive technologies, the LCDs have such advantages as low power consumption, a small volume, a light weight, and a low drive voltage, and are widely applied to camcorders, notebook computers, desktop computers, and various projection devices.

A graphics system can play an image on a display. For example, a computer system can play an image on a flat-panel monitor. To be played, an image is usually represented in a form of image data (for example, RGB data), and the image data is processed to generate a signal for playing. Generally, a standard VGA format is 640 pixels in width and 480 pixels in height. As technologies advance, the graphics system starts to have a higher playback resolution. Therefore, accompanying with this, an increasing requirement on conversion of image data from a first resolution to a second resolution gradually emerges. For this reason, the graphics system should be capable of converting image resolutions. The graphics system is, for example, a graphics controller chip on a main board or a display adapter in a computer system, and an LCD control chip disposed on an LCD.

As the field of display panels develops, higher picture quality has become a main pointer for all display manufacturers. A chrominance viewing angle may be regarded as an important pointer of picture quality for pointing out an important direction for improvement of the all display manufacturers.

### SUMMARY

To resolve the foregoing technical problem, an objective of this application is to provide a graphics processing apparatus and a processing method thereof, to increase a chrominance viewing angle and a penetration rate, and resolve problems of a color cast and a disconnection at a high frequency, thereby improving product quality.

The objective of this application is achieved and the technical problem of this application is resolved by using the following technical solution. A graphics processing apparatus provided according to this application is applied to a display panel for receiving one of a plurality of input graphics and output a corrected graphic according to the input graphic, wherein the graphics processing apparatus comprises: a correction gamma module, configured to adjust a color coordinate of the panel; a first gamma module, configured to: when a primary pixel is input, output a correction module having a correspondence with the first gamma module; a second gamma module, configured to: when a secondary pixel is input, output a correction module having a correspondence with the second gamma module; a first selection and corresponding module, electrically coupled to the first gamma module and the second gamma module separately, and configured to select a high potential output for the primary pixel or select a low potential output for the secondary pixel according to an output potential needed by the primary pixel or the secondary pixel that is corrected by the first gamma module or the second gamma module; and a second selection and corresponding module, electrically coupled to the correction gamma module, the first selection and corresponding module, and a high frequency detection unit separately, and configured to output graphics pixel data.

Another objective of this application is to provide a graphics processing apparatus. The graphics processing apparatus is applied to a display panel for receiving one of a plurality of input graphics and output a corrected graphic according to the input graphic, wherein the graphics processing apparatus comprises: a correction gamma module, configured to adjust a color coordinate of the panel; a first gamma module, configured to: when a primary pixel is input, output a correction module having a correspondence with the first gamma module; a second gamma module, configured to: when a secondary pixel is input, output a correction module having a correspondence with the second gamma module; a first selection and corresponding module, electrically coupled to the first gamma module and the second gamma module separately, and configured to select a high potential output for the primary pixel or select a low potential output for the secondary pixel according to an output potential needed by the primary pixel or the secondary pixel that is corrected by the first gamma module or the second gamma module; and a second selection and corresponding module, electrically coupled to the correction gamma module, the first selection and corresponding module, and a high frequency detection unit separately, and configured to output graphics pixel data, wherein the graphics processing apparatus further comprises a graphics correction unit, configured to: process and identify whether the plurality of input graphics needs to be corrected, and perform correction in a to-be-corrected object area of a to-be-correct object graphic determined by the plurality of input graphics; further comprises a plurality of data-driven chips, a plurality of gate-driven chips, and a power supply control chip; and further comprises a time sequence controller, electrically connected to the graphics correction unit, the plurality of data-driven chips, the plurality of gate-driven chips, and the power supply control chip.

Still another objective of this application is to provide a processing method of a graphics processing apparatus, including: adjusting, by a correction gamma module, a color coordinate of a panel to reach an expected color coordinate; when a primary pixel is input, outputting, by a first gamma module, a correction module having a correspondence with the first gamma module; when a secondary pixel is input, outputting, by a second gamma module, a correction module having a correspondence with the second gamma module; selecting, by a first selection and corresponding module electrically coupled to the first gamma module and the second gamma module separately, a high potential output for the primary pixel or select a low potential output for the secondary pixel according to an output potential needed by the primary pixel or the secondary pixel that is corrected by the first gamma module or the second gamma module; and outputting, by a second selection and corresponding module electrically coupled to the correction gamma module, the first selection and corresponding module, and a high frequency detection unit separately, graphics pixel data.

The technical problem of this application may further be implemented by using the following technical measure.

In an embodiment of this application, the high frequency detection unit is configured to: detect whether an input display picture is of high frequency, and output a high frequency factor to the second selection and corresponding module.

In an embodiment of this application, the second selection and corresponding module determines weights of first output data and second output data according to the high frequency factor.

In an embodiment of this application, a formula for the data output by the second selection and corresponding module is adding a value obtained by multiplying the first output data by the high frequency factor and a value obtained by multiplying the second output data by (1 minus the high frequency factor).

In an embodiment of this application, a graphics correction unit is further comprised, and is configured to: process and identify whether the plurality of input graphics needs to be corrected, and perform correction in a to-be-corrected object area of a to-be-correct object graphic determined by the plurality of input graphics; and a plurality of data-driven chips, a plurality of gate-driven chips, and a power supply control chip are further comprised.

In an embodiment of this application, according to the processing method, the step of the outputting, by a second selection and corresponding module electrically coupled to the correction gamma module, the first selection and corresponding module, and a high frequency detection unit separately, graphics pixel data comprises: determining a result of the graphics pixel data by using the high frequency factor, and determining weights of first output data and second output data, wherein a formula is adding a value obtained by multiplying the first output data by the high frequency factor and a value obtained by multiplying the second output data by (1 minus the high frequency factor).

In an embodiment of this application, according to the processing method, a graphics correction unit is further comprised, wherein the graphics correction unit is configured to: process and identify whether the plurality of input graphics needs to be corrected, and perform correction in a to-be-corrected object area of a to-be-correct object graphic determined by the plurality of input graphics; and a plurality of data-driven chips, a plurality of gate-driven chips, and a power supply control chip are further comprised.

In an embodiment of this application, according to the processing method, a time sequence controller is further comprised, and the time sequence is electrically connected to the graphics correction unit, the plurality of data-driven chips, the plurality of gate-driven chips, and the power supply control chip separately.

According to this application, a chrominance viewing angle and a penetration rate are increased, and problems of a color cast and a disconnection at a high frequency are resolved, product quality is thereby improved.

### BRIEF DESCRIPTION OF THE DRAWINGS

FIG. 1 is a schematic diagram of exemplary pictures of a display device at various viewing angles;

FIG. 2 is a schematic diagram of exemplary curves of a voltage and a penetration rate at a large viewing angle;

FIG. 3a is a schematic diagram of exemplary curves of color cast at a large viewing angle;

FIG. 3b is a schematic diagram of exemplary curves of resolving color cast at a large viewing angle;

FIG. 4 is a schematic diagram of primary pixels and secondary pixels according to an embodiment of this application;

FIG. 5a is a block diagram of a graphics processing apparatus according to an embodiment of this application;

FIG. 5b is a flowchart of a graphics processing method according to an embodiment of this application;

FIG. 6a is a schematic diagram of an exemplary gamma curve;

FIG. 6b is a schematic diagram of a gamma curve according to an embodiment of this application;

FIG. 7 is a flowchart having red pixel correction, green pixel correction, and blue pixel correction data according to an embodiment of this application;

FIG. 8 is a schematic diagram of a gamma curve according to another embodiment of this application; and

FIG. 9 is a flowchart of a graphics processing method according to another embodiment of this application.

### DETAILED DESCRIPTION

The following embodiments are described with reference to the accompanying drawings, which are used to exemplify specific embodiments for implementation of this application Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

In the embodiments of this application, to help explain the storage method of this application, it is assumed that the processing method of this application is performed by a graphics processing apparatus. However, it should be understood that, apparatuses and/or methods may change, and do not need to be associated with each other in work completely according to the below description, and the changes fall within the scope of the current embodiments. It may be understood that in some embodiments, the processing method of this application may be implemented by using a graphics processing apparatus, for example, by operating a driving chip. However, it should be emphasized that unless otherwise stated, the processing methods of this application do not need to be performed according to an actual sequence shown in the figures. Moreover, a plurality of similar blocks may be performed in parallel, instead of being performed according to a sequence. Therefore, elements in the processing methods of this application are referred to as “blocks” rather than “steps” in this specification. It should further be understood that, the processing method may be implemented on variations of the graphics processing apparatus. It may be understood that the processing method of this application may be implemented in a processing system. However, the method may alternatively be implemented in a similar system that has components similar to those in the processing system, but is set with different configurations.

The accompanying drawings and the description are considered to be essentially exemplary, rather than limitative. In figures, units of similar structures are represented by using a same reference number. In addition, for understanding and ease of description, the size and the thickness of each component shown in the accompanying drawings are arbitrarily shown, but this application is not limited thereto.

In the accompanying drawings, for clarity, the thicknesses of a layer, a film, a panel, an area, and the like are enlarged. In the accompanying drawings, for understanding and ease of description, the thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe the technical means adopted in this application to achieve this application objective and effects thereof, specific implementations, structures, features, and effects of a graphics processing apparatus and a processing method thereof provided according to the present disclosure are described in detail below with reference to the drawings and preferred embodiments.

A display panel of this application may include an LCD panel which includes a thin film transistor (TFT) substrate, a color filter (CF) substrate, and a liquid crystal layer formed between the two substrates, an organic light-emitting diode (OLED) panel, or an quantum dots light-emitting diode (QLED) panel.

In an embodiment, the liquid crystal panel of this application may be a curved display panel.

In an embodiment, the TFT and the CF of this application may be formed on a same substrate.

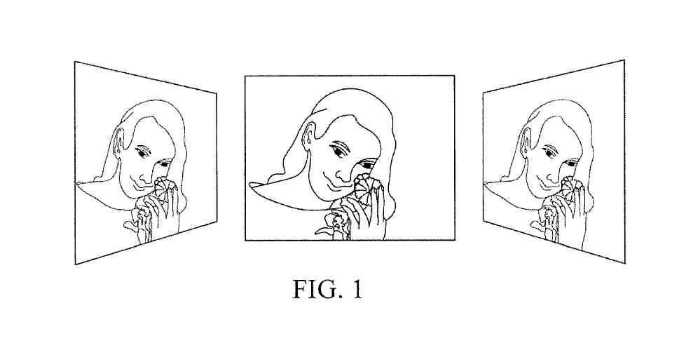

FIG. 1 is a schematic diagram of exemplary pictures of a display device at various viewing angles. Referring to FIG. 1, pictures of a display device at various viewing angles of left 45° and right 45° respectively are shown in FIG. 1. The display pictures at the left 45° and right 45° have a whitening phenomenon.

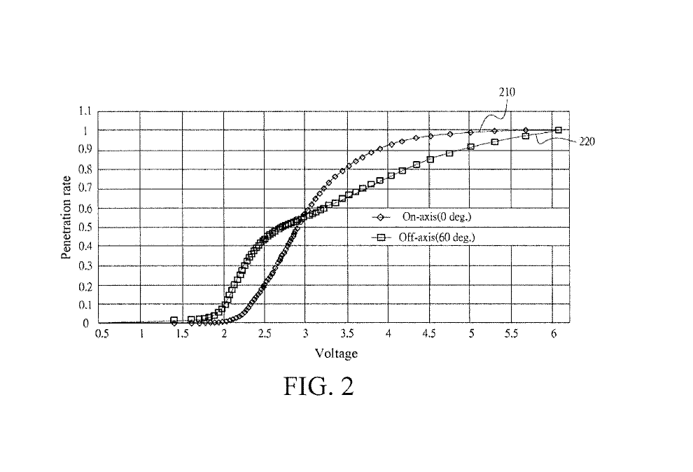

FIG. 2 is a schematic diagram of exemplary curves of a voltage and a penetration rate at a large viewing angle. Referring to FIG. 2, a voltage curve and a penetration rate curve of a display device at a large viewing angle are respectively an on-axis viewing angle curve 210 and a 60° off-axis viewing angle curve 220. The 60° off-axis viewing angle curve 220 results in a decrease in picture contrast and occurrence of a whitening phenomenon.

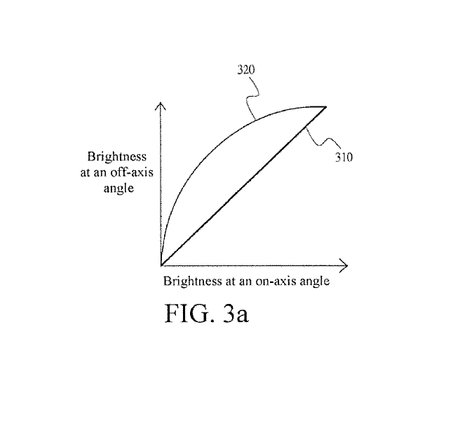

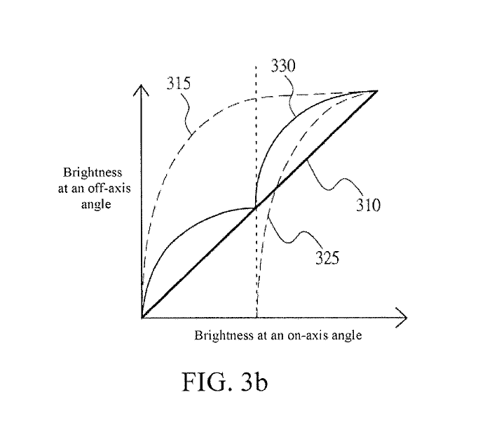

FIG. 3a is a schematic diagram of exemplary curves of color cast at a large viewing angle. FIG. 3b is a schematic diagram of exemplary curves of resolving color cast at a large viewing angle. Referring to FIG. 3a and FIG. 3b, a method for resolving color cast at a viewing angle by a display device is that: A pixel is divided into two parts of a part A and a part B, a conventional display curve 320 is divided into a part A curve 315 and a part B curve 325, the part A curve 315 and the part B curve 325 are mixed to obtain a curve 330 which is close to a linear curve 310, to improve color cast at a viewing angle. However, if a resolution is increased, division of a pixel results in a decrease in a penetration rate.

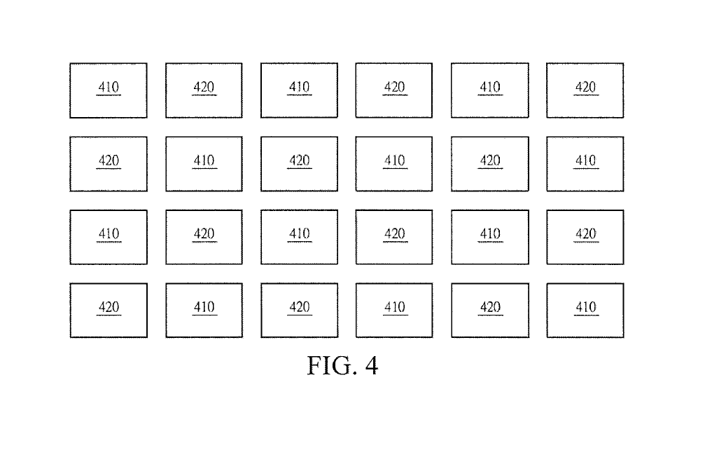

FIG. 4 is a schematic diagram of primary pixels and secondary pixels according to an embodiment of this application. Referring to FIG. 4, each pixel includes three subpixels of red, green, and blue colors. A subpixel is shown in FIG. 4 as a primary pixel 410 and a secondary pixel 420. A voltage greater than a voltage needed for normal displaying is applied to the primary pixel 410, and a voltage less than a voltage less than a voltage needed for normal displaying is applied to the secondary pixel 420. In this way, the primary pixel 410 and the secondary pixel 420 are mixed to enlarge a chrominance viewing angle.

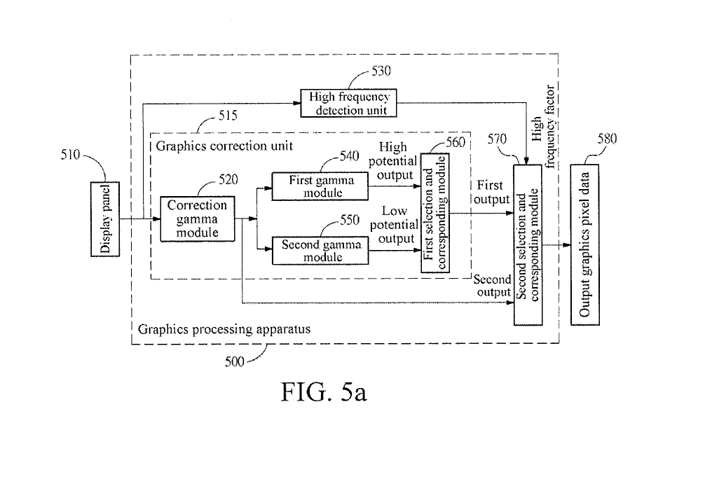

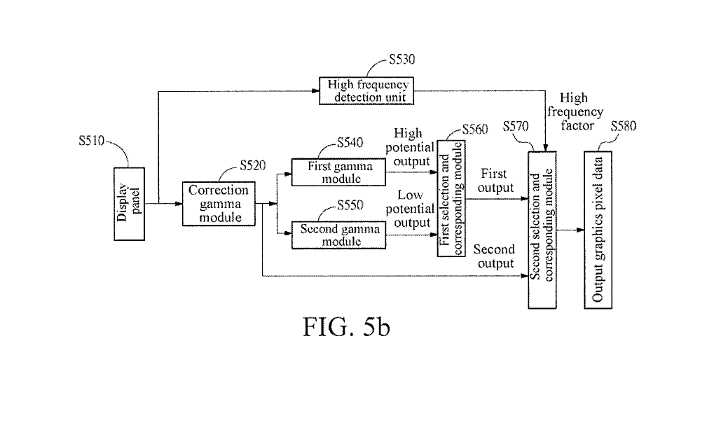

FIG. 5a is a block diagram of a graphics processing apparatus according to an embodiment of this application. FIG. 5b is a flowchart of a graphics processing method according to an embodiment of this application. Referring to FIG. 5a, in an embodiment of this application, a graphics processing apparatus 500 is applied to a display panel 510 for receiving one of a plurality of input graphics, and output a corrected graphic according to the input graphic, wherein the graphics processing apparatus comprises: a correction gamma module 520, configured to adjust a color coordinate of the panel 510; a first gamma module 540, configured to: when a primary pixel is input, output a correction module having a correspondence with the first gamma module 540; a second gamma module 550, configured to: when a secondary pixel is input, output a correction module having a correspondence with the second gamma module 550; a first selection and corresponding module 560, electrically coupled to the first gamma module 540 and the second gamma module 550 separately, and configured to select a high potential output for the primary pixel or select a low potential output for the secondary pixel according to an output potential needed by the primary pixel or the secondary pixel that is corrected by the first gamma module 540 and the second gamma module 550; and a second selection and corresponding module 570, electrically coupled to the correction gamma module 520, the first selection and corresponding module 560, and a high frequency detection unit 530 separately, and configured to output graphics pixel data 580.

In an embodiment, the high frequency detection unit 530 is configured to: detect whether an input display picture is of high frequency, and output a high frequency factor to the second selection and corresponding module 570.

In an embodiment, the second selection and corresponding module 570 determines weights of first output data and second output data according to the high frequency factor.

In an embodiment, a formula for the data output by the second selection and corresponding module 570 is adding a value obtained by multiplying the first output data by the high frequency factor and a value obtained by multiplying the second output data by (1 minus the high frequency factor).

In an embodiment, a graphics correction unit 515 is further included, and is configured to: process and identify whether the plurality of input graphics needs to be corrected, and perform correction in a to-be-corrected object area of a to-be-correct object graphic determined according to the plurality of input graphics; and a plurality of data-driven chips, a plurality of gate-driven chips, and a power supply control chip are further included.

Referring to FIG. 5a, in an embodiment of this application, a graphics processing apparatus 500 is applied to a display panel 510 for receiving one of a plurality of input graphics and output a corrected graphic according to the input graphic, wherein the graphics processing apparatus comprises: a correction gamma module 520, configured to adjust a color coordinate of the panel 510; a first gamma module 540, configured to: when a primary pixel is input, output a correction module having a correspondence with the first gamma module 540; a second gamma module 550, configured to: when a secondary pixel is input, output a correction module having a correspondence with the second gamma module 550; a first selection and corresponding module 560, electrically coupled to the first gamma module 540 and the second gamma module 550 separately, and configured to select a high potential output for the primary pixel or select a low potential output for the secondary pixel according to an output potential needed by the primary pixel or the secondary pixel that is corrected by the first gamma module 540 or the second gamma module 550; and a second selection and corresponding module 570, electrically coupled to the correction gamma module 520, the first selection and corresponding module 560, and a high frequency detection unit 530 separately, and configured to output graphics pixel data 580, wherein the graphics processing apparatus further includes a graphics correction unit 515, configured to: process and identify whether the plurality of input graphics needs to be corrected, and perform correction in a to-be-corrected object area of a to-be-correct object image determined according to the plurality of input graphics; further includes a plurality of data-driven chips (not shown), a plurality of gate-driven chips (not shown), and a power supply control chip (not shown); and further includes a time sequence controller (not shown), electrically connected to the graphics correction unit 515, the plurality of data-driven chips, the plurality of gate-driven chips, and the power supply control chip.

Referring to FIG. 5a and FIG. 5b, in an embodiment of this application, a processing method of the graphics processing apparatus 500 includes: adjusting, by a correction gamma module 520, a color coordinate of a panel 510 to reach an expected color coordinate; when a primary pixel is input, outputting, by a first gamma module 540, a correction module having a correspondence with the first gamma module 540; when a secondary pixel is input, outputting, by a second gamma module 550, a correction module having a correspondence with the second gamma module 550; selecting, by a first selection and corresponding module 560 electrically coupled to the first gamma module 540 and the second gamma module 550 separately, a high potential output for the primary pixel or select a low potential output for the secondary pixel according to an output potential needed by the primary pixel or the secondary pixel that is corrected by the first gamma module 540 or the second gamma module 550; and outputting, by a second selection and corresponding module 570 electrically coupled to the correction gamma module 520, the first selection and corresponding module 550, and a high frequency detection unit 530 separately, graphics pixel data.

In an embodiment, according to the processing method, the step of outputting, by a second selection and corresponding module 570 electrically coupled to the correction gamma module 520, the first selection and corresponding module 560, and a high frequency detection unit 530 separately, graphics pixel data includes: determining a result of the graphics pixel data by using a high frequency factor, and determining weights of first output data and second output data, where a formula is adding a value obtained by multiplying the first output data by the high frequency factor and a value obtained by multiplying the second output data by (1 minus the high frequency factor).

In an embodiment, according to the processing method, a graphics correction unit 515 is further included, and is configured to: process and identify whether the plurality of input graphics needs to be corrected, and perform correction in a to-be-corrected object area of a to-be-correct object graphic determined according to the plurality of input graphics; and a plurality of data-driven chips, a plurality of gate-driven chips, and a power supply control chip are included.

In an embodiment, according to the storage method, a time sequence controller is further included, and is electrically connected to the graphics correction unit 515, the plurality of data-driven chips, the plurality of gate-driven chips, and the power supply control chip separately.

Referring to FIG. 5b, in block S510, graphics pixel data is input.

Referring to FIG. 5b, in block S520, a color coordinate of a panel is adjusted by a correction gamma module to reach an expected color coordinate.

Referring to FIG. 5b, in block S530, weights of first output data and second output data are determined by using a high frequency factor.

Referring to FIG. 5b, in block S540, when a primary pixel is input, a correction module having a correspondence with a first gamma module is output by the first gamma module.

Referring to FIG. 5b, in block S550, when a secondary pixel is input, a correction module having a correspondence with a second gamma module is output by the second gamma module.

Referring to FIG. 5b, in block S560, a high potential output is selected for the primary pixel or a low potential output is selected for the secondary pixel by a first selection and corresponding module electrically coupled to the first gamma module and the second gamma module separately according to an output potential needed by the primary pixel or the secondary pixel that is corrected by the first gamma module or the second gamma module.

Referring to FIG. 5b, in block S570, a second selection and corresponding module is electrically coupled to the correction gamma module, the first selection and corresponding module, and a high frequency detection unit separately.

Referring to FIG. 5b, in block S580, graphics pixel data is output.

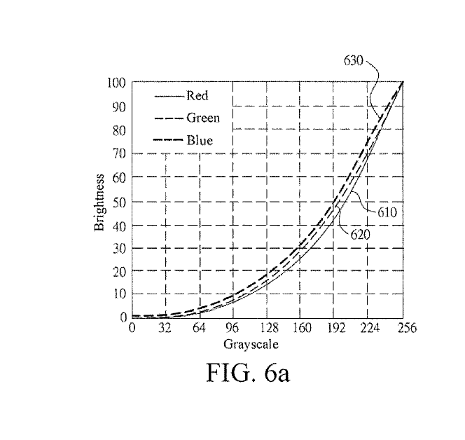

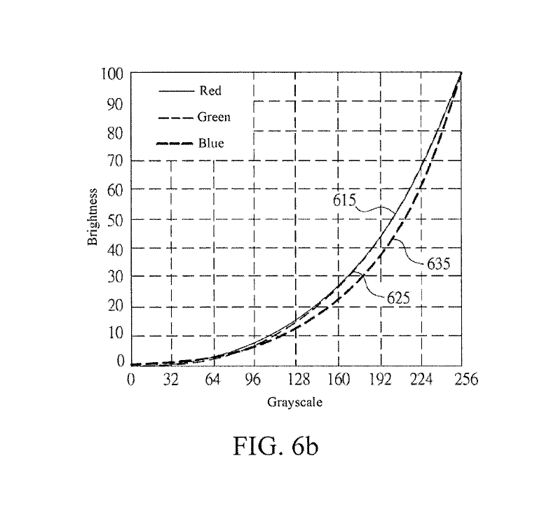

FIG. 6a is a schematic diagram of an exemplary gamma curve. FIG. 6b is a schematic diagram of a gamma curve according to an embodiment of this application. Referring to FIG. 6a, an original gamma curve has a red gamma curve 610, a green gamma curve 620, and a blue gamma curve 630.

Referring to FIG. 6b, in an embodiment, a gamma curve having white balance includes a red gamma curve 615, a green gamma curve 625, and a blue gamma curve 635.

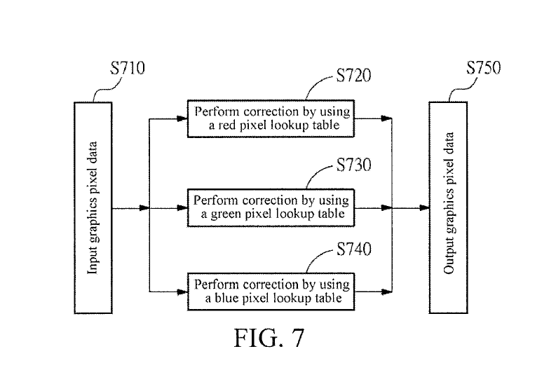

FIG. 7 is a flowchart having red pixel correction, green pixel correction, and blue pixel correction data according to an embodiment of this application. Referring to FIG. 7, in procedure S710, graphics pixel data is input.

Referring to FIG. 7, in procedure S720, correction is performed by using a red pixel lookup table.

Referring to FIG. 7, in procedure S730, correction is performed by using a green pixel lookup table.

Referring to FIG. 7, in procedure S740, correction is performed by using a blue pixel lookup table.

Referring to FIG. 7, in procedure S750, graphics pixel data is output.

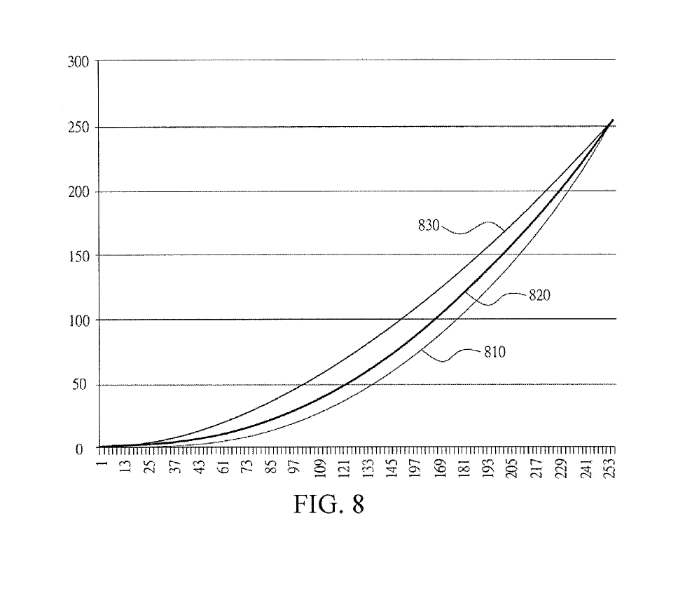

FIG. 8 is a schematic diagram of a gamma curve according to another embodiment of this application. As shown in FIG. 8, a first gamma module has a hardware architecture similar to that of a correction gamma module, and by using three lookup tables of red, green, and blue colors, a grayscale value that corresponds to the primary pixel and that is greater than a display grayscale is obtained. A second gamma module has a hardware architecture similar to that of the correction gamma module, and by using three lookup tables of red, green, and blue colors, a grayscale value that corresponds the secondary pixel and that is less than a display grayscale is obtained. Rules for correcting the lookup tables of red, green, and blue colors of the first gamma module curve 830 and correcting the lookup tables of red, green, and blue colors of the second gamma module curve 810 are shown in FIG. 8 below. By mixing the first gamma module curve 830 and the second gamma module curve 810, a standard gamma curve 820 may be obtained, as shown in FIG. 8 (for example, the standard gamma curve 820 is 2.2).

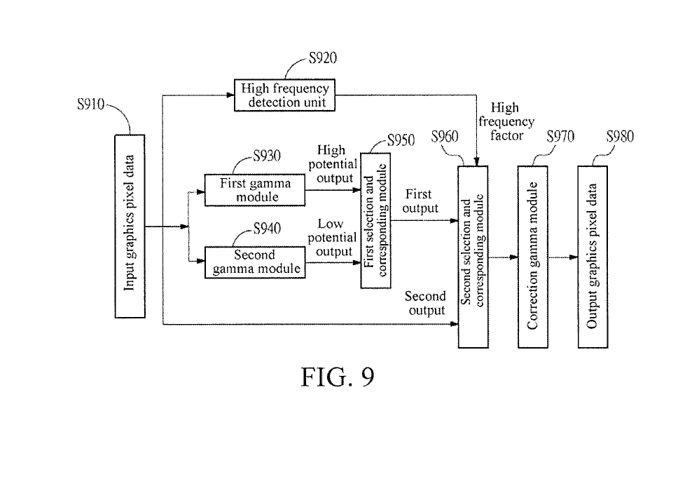

FIG. 9 is a flowchart of a graphics processing method according to another embodiment of this application. Referring to FIG. 9, in block S910, graphics pixel data is input.

Referring to FIG. 9, in block S920, weights of first output data and second output data are determined by using a high frequency factor.

Referring to FIG. 9, in block S930, when a primary pixel is input, a correction module having a correspondence with a first gamma module is output by the first gamma module.

Referring to FIG. 9, in block S940, when a secondary pixel is input, a correction module having a correspondence with a second gamma module is output by the second gamma module.

Referring to FIG. 9, in block S950, a high potential output is selected for the primary pixel or a low potential output is selected for the secondary pixel by a first selection and corresponding module electrically coupled to the first gamma module and the second gamma module separately according to an output potential needed by the primary pixel or the secondary pixel that is corrected by the first gamma module or the second gamma module.

Referring to FIG. 9, in block S960, a second selection and corresponding module is electrically coupled to the correction gamma module, the first selection and corresponding module, and a high frequency detection unit separately.

Referring to FIG. 9, in block S970, a color coordinate of a panel is adjusted by a correction gamma module to reach an expected color coordinate.

Referring to FIG. 9, in block S980, graphics pixel data is output.

According to this application, a chrominance viewing angle and a penetration rate are increased, and problems of a color cast and a disconnection at a high frequency are resolved, product quality is thereby improved.

Terms such as “in some embodiments” and “in various embodiments” are repeatedly used. Usually, the terms do not refer to a same embodiment; but they can refer to a same embodiment. Words such as “comprise”, “have”, “include” are synonyms, unless other meanings are indicated in the context.

Descriptions above are merely specific embodiments of this application, and are not intended to limit this application. Although this application has been disclosed above through the specific embodiments, the embodiments are not intended to limit this application. A person skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of this application without departing from the content of the technical solutions of this application shall fall within the scope of the technical solutions of this application.

What is claimed is:

1. A graphics processing apparatus, applied to a display panel for receiving one of a plurality of input graphics and output a corrected graphic according to the input graphic, wherein the graphics processing apparatus comprises:
a correction gamma module, configured to adjust a color coordinate of the panel;
a first gamma module, configured to: when a primary pixel is input, output a correction module having a correspondence with the first gamma module;
a second gamma module, configured to: when a secondary pixel is input, output a correction module having a correspondence with the second gamma module;
a first selection and corresponding module, electrically coupled to the first gamma module and the second gamma module separately, and configured to select a high potential output for the primary pixel or select a low potential output for the secondary pixel according to an output potential needed by the primary pixel or the secondary pixel that is corrected by the first gamma module or the second gamma module; and
a second selection and corresponding module, electrically coupled to the correction gamma module, the first selection and corresponding module, and a high frequency detection unit separately, and configured to output graphics pixel data.

2. The graphics processing apparatus according to claim 1, wherein the high frequency detection unit is configured to detect whether an input display picture is of high frequency.

3. The graphics processing apparatus according to claim 2, wherein the high frequency detection unit outputs a high frequency factor to the second selection and corresponding module.

4. The graphics processing apparatus according to claim 3, wherein the second selection and corresponding module determines weights of first output data and second output data according to the high frequency factor.

5. The graphics processing apparatus according to claim 4, wherein a formula for the data output by the second selection and corresponding module is adding a value obtained by multiplying the first output data by the high frequency factor and a value obtained by multiplying the second output data by (1 minus the high frequency factor).

6. The graphics processing apparatus according to claim 1, further comprising a plurality of data-driven chips, a plurality of gate-driven chips, and a power supply control chip.

7. The graphics processing apparatus according to claim 1, further comprising a graphics correction unit, configured to: process and identify whether the plurality of input graphics needs to be corrected, and perform correction in a to-be-corrected object area of a to-be-correct object graphic determined according to the plurality of input graphics.

8. A graphics processing apparatus, applied to a display panel for receiving one of a plurality of input graphics and output a corrected graphic according to the input graphic, wherein the graphics processing apparatus comprises:
a correction gamma module, configured to adjust a color coordinate of the panel;
a first gamma module, configured to: when a primary pixel is input, output a correction module having a correspondence with the first gamma module;
a second gamma module, configured to: when a secondary pixel is input, output a correction module having a correspondence with the second gamma module;
a first selection and corresponding module, electrically coupled to the first gamma module and the second gamma module separately, and configured to select a high potential output for the primary pixel or select a low potential output for the secondary pixel according to an output potential needed by the primary pixel or the secondary pixel that is corrected by the first gamma module or the second gamma module; and
a second selection and corresponding module, electrically coupled to the correction gamma module, the first selection and corresponding module, and a high frequency detection unit separately, and configured to output graphics pixel data, wherein the graphics processing apparatus further comprises a graphics correction unit, configured to: process and identify whether the plurality of input graphics needs to be corrected, and perform correction in a to-be-corrected object area of a to-be-correct object graphic determined according to the plurality of input graphics; and further comprises a time sequence controller, electrically connected to the graphics correction unit, a plurality of data-driven chips, a plurality of gate-driven chips, and a power supply control chip.

9. A processing method of a graphics processing apparatus, comprising:
adjusting, by a correction gamma module, a color coordinate of a panel to reach an expected color coordinate;
when a primary pixel is input, outputting, by a first gamma module, a correction module having a correspondence with the first gamma module;
when a secondary pixel is input, outputting, by a second gamma module, a correction module having a correspondence with the second gamma module;
selecting, by a first selection and corresponding module electrically coupled to the first gamma module and the second gamma module separately, a high potential output for the primary pixel or select a low potential output for the secondary pixel according to an output potential needed by the primary pixel or the secondary pixel that is corrected by the first gamma module or the second gamma module; and
outputting, by a second selection and corresponding module electrically coupled to the correction gamma module, the first selection and corresponding module, and a high frequency detection unit separately, graphics pixel data.

10. The processing method of a graphics processing apparatus according to claim 9, wherein the step of the outputting, by a second selection and corresponding module electrically coupled to the correction gamma module, the first selection and corresponding module, and a high frequency detection unit separately, graphics pixel data comprises: determining a result of the graphics pixel data by using a high frequency factor, and determining weights of first output data and second output data.

11. The processing method of a graphics processing apparatus according to claim 10, wherein the high frequency detection unit is configured to detect whether an input display picture is of high frequency.

12. The processing method of a graphics processing apparatus according to claim 11, wherein the high frequency detection unit outputs the high frequency factor to the second selection and corresponding module.

13. The processing method of a graphics processing apparatus according to claim 10, wherein a formula for the data output by the second selection and corresponding module is adding a value obtained by multiplying the first output data by the high frequency factor and a value obtained by multiplying the second output data by (1 minus the high frequency factor).

14. The processing method of a graphics processing apparatus according to claim 9, wherein a plurality of data-driven chips, a plurality of gate-driven chips, and a power supply control chip are further comprised.

15. The processing method of a graphics processing apparatus according to claim 14, wherein the graphics correction unit is configured to: process and identify whether the plurality of input graphics needs to be corrected, and perform correction in a to-be-corrected object area of a to-be-correct object graphic determined according to the plurality of input graphics.

16. The processing method of a graphics processing apparatus according to claim 14, wherein a time sequence controller is further comprised, and the time sequence is electrically connected to the graphics correction unit, the plurality of data-driven chips, the plurality of gate-driven chips, and the power supply control chip separately.
